(19) United States
(12) Patent Application Publication
(10) Pub. No.: US 2016/0036374 A1
(43) Pub. Date: Feb. 4, 2016

(54) SOLAR CELL SUPPORT ASSEMBLY

(71) Applicant: BYD COMPANY LIMITED, Shenzhen, Guangdong (CN)

(72) Inventors: Jun GE, Shenzhen (CN); Liguo WANG, Shenzhen (CN); Hongbin WANG, Shenzhen (CN); Long HE, Shenzhen (CN); Jiaolian XU, Shenzhen (CN)

(21) Appl. No.: 14/772,511

(22) PCT Filed: Apr. 23, 2014
(86) PCT No.: PCT/CN2014/076060

§ 371 Date: Sep. 3, 2015

(30) Foreign Application Priority Data
Apr. 25, 2013 (CN) 201320213359.8

(51) Int. Cl. H02S 20/30

(52) U.S. Cl. CPC H02S 20/30

(57) ABSTRACT

A solar cell support assembly includes: a first supporting (1), a second supporting members (7), a beam (2) pivotably connected to the first supporting member (1) and configured to mount the solar cell thereon, a first swing bar (4) connected to the beam (2) and configured to rotate the beam (2); a second swing bar (6) pivotably connected to the second supporting member (7); a first pushrod (51) pivotably connected to the first swing bar (4) and the second swing bar (6); a second pushrod (52) pivotably connected to the first swing bar (4) and the second swing bar (6); and a driving device (9) pivotably connected to the second swing bar (6) and configured to drive the second swing bar (6) to rotate relative to the second supporting member (7).

### CROSS-REFERENCE TO RELATED APPLICATION

This application claims priority to, and benefits of Chinese Patent Application Serial No. 201320213359.8, filed with the State Intellectual Property Office of China, on Apr. 25, 2013, the entire content of which is incorporated herein by reference.

### FIELD

Exemplary embodiments of the present disclosure relate generally to a solar cell field, and more particularly to a solar cell support assembly.

### BACKGROUND

As is known to all, a solar cell support assembly in the related art includes two types, a fixed supporter and a tracking supporter. The tracking supporter is widely used, because it may enlarge the effective light absorption area, thus increasing the daily electric energy production of the solar cell.

When a conventional tracking supporter is used in the practical application of the solar power station, one pushrod is driven by a driving device, thus driving the solar cell module to rotate according to a position of sun. In such above manner, a solar cell with a large-scale solar array requires a sufficient force applied on the pushrod to drive the tracking supporter. Therefore, a lot of energy is consumed in order to achieve the purpose of tracking sun.

### SUMMARY

Embodiments of the present disclosure seek to solve at least one of the problems. According to an embodiment of the present disclosure, a solar cell support assembly which needs less driving force to rotate is provided. The solar cell support assembly includes first and second supporting members; a beam pivotably connected to the first supporting member and configured to mount the solar cell thereon; a first swing bar connected to the beam and configured to rotate the beam; a second swing bar pivotably connected to the second supporting member; a first pushrod pivotably connected to the first swing bar and the second swing bar; a second pushrod pivotably connected to the first swing bar and the second swing bar; and a driving device pivotably connected to the second swing bar and configured to drive the second swing bar to rotate relative to the second supporting member.

In some embodiments, the first and second pushrods are substantially parallel to each other.

In some embodiments, the first swing bar defines a first end pivotably connected to the first pushrod and a second end pivotably connected to the second pushrod.

In some embodiments, the first pushrod defines a first proximal end pivotably connected to the second swing bar via a first pivot shaft adjacent to a first end of the second swing bar, wherein the second pushrod defines a second proximal end pivotably connected to the second swing bar via a second pivot shaft, wherein the second supporting member is pivotably connected to the second swing bar via a third pivot shaft, the third pivot shaft is between the first and second pivot shafts on the second swing bar, wherein the driving device is pivotably connected to the second swing bar via a fourth pivot shaft adjacent to a second end of the second swing bar.

In some embodiments, axes of the third pivot shaft and the beam are located in the same horizontal plane.

In some embodiments, the third pivot shaft is located at a middle point between the first and second pivot shafts.

In some embodiments, the fourth pivot shaft is formed away from the second pivot shaft. In some embodiments, the fourth pivot shaft is formed at a lower end of the second swing bar.

In some embodiments, the first pivot shaft is formed at an upper end of the second swing bar.

In some embodiments, the beam is supported on the first supporting member via a bearing.

In some embodiments, a connection position of the first swing bar with the beam is located at a middle point between the first end and the second end of the first swing bar.

In some embodiments, the solar cell support assembly further comprising a mounting frame mounted on the beam and configured to mount the solar battery pack thereon.

In some embodiments, the solar cell support assembly further comprising a supporting bracket, and the driving device is mounted on the supporting bracket.

In some embodiments, the driving device comprises a screw hoist, a drive motor connected to the screw hoist, and a driving rod connected to the screw hoist and the second swing bar, the second swing bar is driven to swing by the screw hoister via the driving rod.

In some embodiments, a plurality of beams, a plurality of the first swing bars and a plurality of the first supporting members are provided in a one to one correspondence relationship.

In some embodiments, the first swing bar and the beam is formed integrally

In some embodiments, the first swing bar is welded with the beam.

In some embodiments, the first swing bar is connected with the beam via a bolt.

With a four rod linkage consisted of the first swing bar, the second swing bar, the first pushrod and the second pushrod, a moment of force driving the solar cell to rotate is formed into a force couple, thus decreasing the energy consumption of the rotation of the solar cell. Moreover, the solar cell support assembly according to the embodiments of the present disclosure also can reduce the horizontal component force applied on the first supporting member, so as to ensure stability and durability of the whole solar cell support assembly.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the drawings, in which:

FIG. 1 is a side view of a solar cell support assembly according to an embodiment of the present disclosure, in which the battery pack is in a horizontal position;

FIG. 2 is a side view of a solar cell support assembly according to an embodiment of the present disclosure, in which the battery pack is rotated to a 45-degree angle position relative to the horizontal plane;

FIG. 3 is a top view of a solar cell support assembly according to an embodiment of the present disclosure.

### DETAILED DESCRIPTION

Reference will be made in detail to embodiments of the present disclosure. The embodiments described herein with reference to drawings are explanatory, illustrative, and used to generally understand the present disclosure. The embodiments shall not be construed to limit the present disclosure. The same or similar elements and the elements having same or similar functions are denoted by like reference numerals throughout the descriptions.

It would be appreciated by those skilled in the related art that phraseology and terminology used herein with reference to device or element orientation (such as, terms like “longitudinal”, “lateral”, “up”, “down”, “front”, “rear”, “left”, “right”, “vertical”, “horizontal”, “top”, “bottom”, “inside”, “outside”) are only used to simplify description of the present disclosure, and do not indicate or imply that the device or element referred to must have or operated in a particular orientation. They cannot be seen as limits to the present disclosure.

In the description, terms concerning attachments, coupling and the like, such as “connected” and “interconnected”, refer to a relationship in which structures are secured or attached to one another through mechanical or electrical connection, or directly or indirectly through intervening structures, unless expressly described otherwise. Specific implications of the above phraseology and terminology may be understood by those skilled in the art according to specific situations.

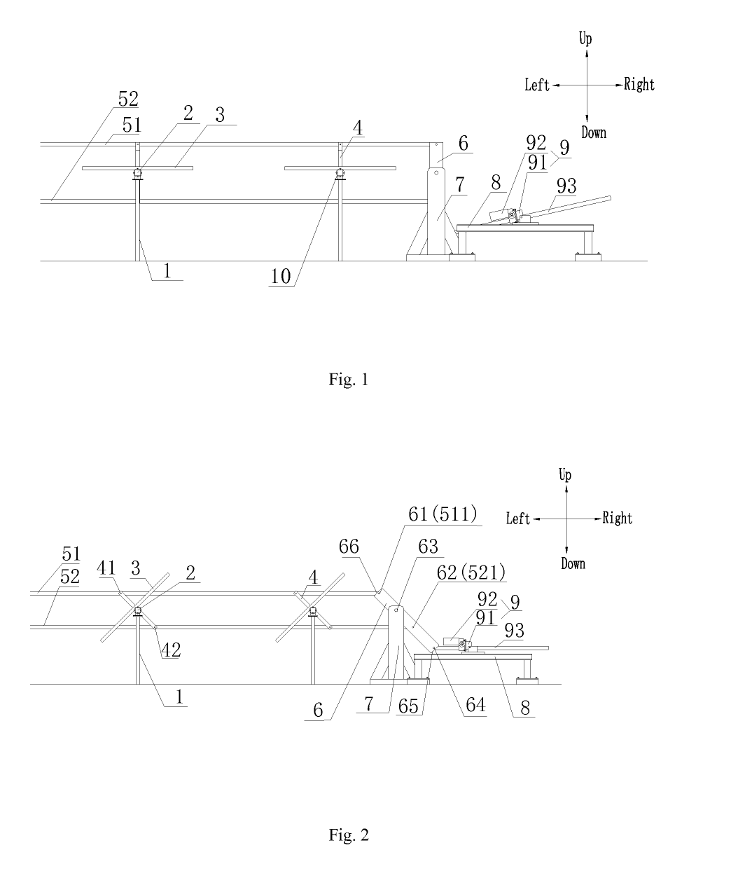

As shown in FIG. 1 to FIG. 3, a solar cell support assembly according to embodiments of the present disclosure is provided. The solar cell support assembly includes a first supporting member 1, a beam 2, a mounting frame 3, a first swing bar 4, a first pushrod 51, a second pushrod 52, a second swing bar 6, a second supporting member 7 and driving device 9.

In some of embodiments, as shown in FIG. 1 and FIG. 2, the first supporting member 1 is disposed vertically, i.e. the first supporting member 1 is disposed in a direction of up-down as shown in FIG. 1 and FIG. 2, the beam 2 is pivotably connected to the first supporting member 1 and is perpendicular to the first supporting member 1. The mounting frame 3 for mounting a solar battery pack is fixedly connected with the beam 2, so that the solar battery pack 1 mounted to the mounting frame 3 can be rotated along with the rotation of the beam 2.

The first swing bar 4 is fixedly connected with the beam 2 to drive the beam 2 to rotate relative to the first supporting member 1. The first swing bar 4 and the beam 2 may be formed integrally. Alternately, the first swing bar 4 may be welded with the beam 2 or the first swing bar 4 may be connected to the beam 2 by a bolt. As shown in FIGS. 1 and 2, a connection position of the first swing bar 4 with the beam 2 is located at a middle point between the first end 41 and the second end 42 of the first swing bar 4.

The first pushrod 51 is pivotably connected to the first end 41 of the first swing bar 4, i.e. an upper end of the first swing bar 4, and a second pushrod 52 is pivotably connected the second end 42 of the first swing bar, i.e. a lower end of the first swing bar 4. The second swing bar 6 is respectively pivotably connected a first proximal end 511 of the first pushrod 51 and a second proximal end 521 of the second pushrod 52. The proximal ends 511 and 521 of the first and second pushrod 51, 52 are ends adjacent to the second swing bar 6, in other words, the proximal ends 511 and 521 is right ends of the first and second pushrod 51, 52 as shown in FIG. 1 and FIG. 2.

Thus, the first swing bar 4, second swing bar 6, first pushrod 51 and second pushrod 52 form a four bar linkage, so that the second swing bar 6 swings, then the first swing bar 4 is driven to swing.

The second supporting member 7 is disposed vertically and in a same straight line with the first supporting member 1. The second swing bar 6 is pivotably connected the second supporting member 7. The driving device 9 is pivotably connected the second swing bar 6 and configured to drive the second swing bar 6 to swing relative to the second supporting member 7. The driving motion of the driving device 9 is a reciprocating movement, so that the beam 2 is driven to perform a reciprocating rotation relative to the first supporting member 4 by the four bar linkage.

For instance, during a process of the second swing bar 6 swinging from a vertical position as shown in FIG. 2 to a inclined position as shown in FIG. 1, the first and second pushrods 51, 52 are driven to move to a lower-left direction and a upper-right direction respectively by a reciprocating motion of the four bar linkage, so that the first swing bar 4 is driven to swing to an inclined position as shown in FIG. 2 from a vertical position as shown in FIG. 1. Meanwhile, the mounting frame 3 fixedly connected with the beam 2 is driven to rotate to an inclined position shown in FIG. 2 from a horizontal position shown in FIG. 1 by the motion of the beam 2.

The driving device 9 drives the second swing bar 6 to swing in a reverse direction, i.e. driving the second swing bar 6 to swing from the inclined position to the vertical position, then the mounting frame 3 can rotate back to the horizon position from the inclined position. That is, the mounting frame 3 rotates in a reciprocating movement which is between the horizontal position and the inclined position. Thus, the solar cell support assembly according to embodiments of the present disclosure can rotate to track position of sun in real time.

With the four bar linkage formed by the first swing bar 4, second swing bar 6, first pushrod 51 and second pushrod 52, when the second swing bar 6 is swung, the two ends 41, 42 of the first swing bar 4 are applied two driving forces with different directions by the first and second pushrods 51, 52, so as to easily drive the beam 2 to rotate. Thus, a moment of force driving the battery pack to rotate is formed into a force couple, so that the energy consumption of the rotation of the battery pack can be reduced. Moreover, the solar cell support assembly according to the embodiments of the present disclosure also can reduce the horizontal component force applied on the first supporting member 1, so as to ensure stability and durability of the whole solar cell support assembly. The above mentioned term of “pivotably” means a type of connection that rotating around a connecting point, for example, “the second swing bar 6 is pivotably connected a second supporting member 7” means that the second swing bar 6 is connected with the second supporting member 7 at a connecting point, and may rotate around the connecting point.

In some of embodiments, the solar cell support assembly according to embodiments of the present disclosure may include a plurality of the first supporting member 1 spaced with each other in a straight line, the number of the first supporting member 1 is adjustable according to a size of the solar cell support assembly and actual need. A distance between adjacent first supporting members 1 is equal, so that each of the mounting frames can obtain enough space to rotate without interfering with each other. Correspondingly, the solar cell support assembly includes a plurality of beams 2 and a plurality of the first swing bar 4, and numbers of the beams 2 and the first swing bar 4 are equal to that of the first supporting member 1. One first supporting member 1, one beam 2 and one first swing bar 4 can form a solar cell supporting unit, in other words, the plurality of the first supporting member 1, the plurality of the beams 2 and the plurality of the first swing bars 4 are provided in a one to one correspondence relationship.

Whole solar cell supporting unit in the same solar cell support assembly moves in a linkage manner, in other words, every first swing bar 4 can form an individual four bar linkage with the first and second pushrod 51, 52 and the second swing bar 6. So that the solar cell support assembly can easily drive the plurality of solar cell support units to rotate with less power consumption. In some embodiments, the first pushrod 51 and the second pushrod 52 are parallel with each other all the time, such that the first pushrod 51 and the second pushrod 52 can better cooperate to drive the first swing bar 4. However, it is hardly to maintain the first pushrod 51 and the second pushrod 52 absolutely parallel with each other in practice usage or assembling, however, a substantially or approximately parallel relationship between the first pushrod 51 and the second pushrod 52 is acceptable and will be regarded as a parallel relationship.

Keeping the first pushrod 51 and the second pushrod 52 in parallel to each other is just a preferred option. In the actual assembling, although the first pushrod 51 and the second pushrod 52 are not in absolutely parallel to each other, the linkage effect of the four bar linkage can be achieved by keeping the first pushrod 51 and the second pushrod 52 substantially or approximately parallel with each other.

In some embodiments, as shown in FIG. 2, the second swing bar 6 has a first pivot shaft 61, a second pivot shaft 62, a third pivot shaft 63 and a fourth pivot shaft 64. The first proximal end 511 of the first pushrod 51 is pivotably connected second swing bar 6 via the first pivot shaft 61, the second proximal end 521 of second pushrod 52 is pivotably connected the second swing bar 6 via the second pivot shaft 62, the second supporting member 7 is pivotably connected the second swing bar 6 via the third pivot shaft 63, and the driving device 9 is pivotably connected the second swing bar 6 via the fourth pivot shaft 64.

The third pivot shaft 63 is formed between the first and second pivot shafts 61 and 62, so that a force transmission effect of the four bar linkage is improved. More particularly, the third pivot shaft 63 is positioned at a middle point between the first pivot shaft 61 and the second pivot shaft 62 in a direction of length of the second swing bar 6. In addition, the first pivot shaft 61 may be formed at an upper end 66 of the second swing bar 6.

The third pivot shaft 63 and the beam 2 are located in a same horizontal plane, more particularly, axes of the beam 2 and the third pivot shaft 63 are located in the same horizontal plane.

A distance between the fourth pivot shaft 64 and the second pivot shaft 62 is as long as possible, for example, the fourth pivot shaft 64 may be disposed at the lower end 65. Thus, a length of an arm of the force for driving the second swing bar 6 to move can be enlarged, and the force for driving the second swing bar 6 can be further reduced.

The driving device 9 is mounted on a supporting bracket 8 and includes a screw hoist 91, a drive motor 92 connected to the screw hoist 91, and a driving rod 93 connected to the screw hoist 91 and the second swing bar 6. The driving rod 93 is pivotably connected to the second swing bar 6 via the fourth pivot shaft 64, so that the second swing bar 6 is driven to swing by the screw hoister 91 via the driving rod 93.

The driving device 9 is a conventional drive device for the solar cell support assembly, it would be appreciated by those skilled in the related art that the embodiments of the present disclosure cannot be construed to limit the structure or type of the driving device 9, and the driving device 9 can be any suitable drive device commonly used in the related art.

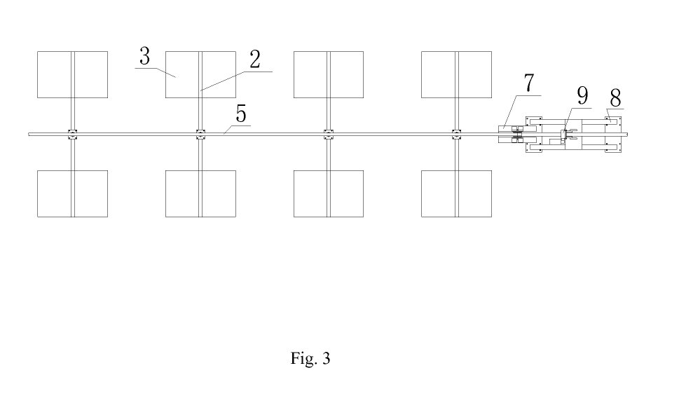

At least one mounting frame 3 is disposed on each of the beams 9, the number of the mounting frame 3 for each of the beams 9 can be adjusted according to a requirement of power generation or a motor load of the driving device 9. As shown in FIG. 3, a pair of the mounting frames 8 is disposed on two sides of each beam 2 symmetrically.

The FIGS. 1-3 are just schematic diagrams, although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

1. A solar cell support assembly, comprising:
a first supporting member and a second supporting member;
a beam pivotably connected to the first supporting member and configured to mount a solar battery pack thereon;
a first swing bar connected to the beam and configured to rotate the beam;
a second swing bar pivotably connected to the second supporting member;
a first pushrod pivotably connected to the first swing bar and the second swing bar;
a second pushrod pivotably connected to the first swing bar and the second swing bar; and
a driving device pivotably connected to the second swing bar and configured to drive the second swing bar to rotate relative to the second supporting member.

2. The solar cell support assembly according to claim 1, wherein the first and second pushrods are substantially parallel to each other.

3. The solar cell support assembly according to claim 2, wherein the first swing bar defines a first end pivotably connected to the first pushrod and a second end pivotably connected to the second pushrod.

4. The solar cell support assembly according to claim 3, wherein the first pushrod defines a first proximal end pivotably connected to the second swing bar via a first pivot shaft adjacent to a first end of the second swing bar,
wherein the second pushrod defines a second proximal end pivotably connected to the second swing bar via a second pivot shaft,
wherein the second supporting member is pivotably connected to the second swing bar via a third pivot shaft, and the third pivot shaft is between the first and second pivot shafts on the second swing bar,
wherein the driving device is pivotably connected to the second swing bar via a fourth pivot shaft adjacent to a second end of the second swing bar.

5. The solar cell support assembly according to claim 4, wherein axes of the third pivot shaft and the beam are located in a same horizontal plane.

6. The solar cell support assembly according to claim 4, wherein the third pivot shaft is located at a middle point between the first and second pivot shafts.

7. The solar cell support assembly according to claim 4, wherein the fourth pivot shaft is formed away from the second pivot shaft.

8. The solar cell support assembly according to claim 7, wherein the fourth pivot shaft is formed at a lower end of the second swing bar.

9. The solar cell support assembly according to claim 7, wherein the first pivot shaft is formed at an upper end of the second swing bar.

10. The solar cell support assembly according to claim 9, wherein the beam is supported on the first supporting member via a bearing.

11. The solar cell support assembly according to claim 3, wherein a connection position of the first swing bar with the beam is located at a middle point between the first end and the second end of the first swing bar.

12. The solar cell support assembly according to claim 11, further comprising a mounting frame mounted on the beam and configured to mount the solar battery pack thereon.

13. The solar cell support assembly according to claim 12, further comprising a supporting bracket, and the driving device is mounted on the supporting bracket.

14. The solar cell support assembly according to claim 13, wherein the driving device comprises a screw hoist, a drive motor connected to the screw hoist, and a driving rod connected to the screw hoist and the second swing bar, and the second swing bar is driven to swing by the screw hoister via the driving rod.

15. The solar cell support assembly according to claim 14, wherein a plurality of beams, a plurality of the first swing bars and a plurality of the first supporting members are provided in a one to one correspondence relationship.

16. The solar cell support assembly according to claim 15, wherein the first swing bar and the beam is formed integrally.

17. The solar cell support assembly according to claim 16, wherein the first swing bar is welded with the beam.

18. The solar cell support assembly according to claim 17, wherein the first swing bar is connected with the beam via a bolt.
